(19) United States
(12) Patent Application Publication
(10) Pub. No.: US 2025/0039608 A1
(43) Pub. Date: Jan. 30, 2025

(54) HEADREST APPARATUS AND METHOD FOR PROVIDING SURROUND SOUND EXPERIENCE

(71) Applicant: Atlas Headrest LLC, Holland, MI (US)

(72) Inventor: Andrew Michael Foley, Holland, MI (US)

(73) Assignee: Atlas Headrest LLC, Holland, MI (US)

(21) Appl. No.: 18/768,664

(22) Filed: Jul. 10, 2024

Related U.S. Application Data
(60) Provisional application No. 63/515,725, filed on Jul. 26, 2023.

(51) Int. Cl. H04R 5/02; A47C 7/38; A47C 7/72; H04S 3/00

(52) U.S. Cl. CPC H04R 5/023; A47C 7/38; A47C 7/727; H04S 3/008; H04R 2205/024; H04R 2410/05; H04R 2420/07; H04R 2430/01; H04S 2400/05; H04S 2400/13

(57) ABSTRACT

A headrest apparatus, a method, and a computer program product is provided for providing surround sound experience to user. The headrest apparatus receives an audio portion of a media content from an electronic device. The headrest apparatus determines a plurality of audio channel signals from the received audio portion. The determined plurality of audio channel signals includes at least a first set of audio channel signals. The headrest apparatus further controls a first audio rendering device, embedded at a first position in the headrest apparatus, to output a first audio channel signal of the first set of audio channel signals. The headrest apparatus further controls a second audio rendering device, embedded at a first position in the headrest apparatus, to output a second audio channel signal of the first set of audio channel signals.

### CROSS-REFERENCE TO RELATED APPLICATIONS

This application claims the benefit of U.S. Provisional Application No. 63/515,725, filed Jul. 26, 2023, which is incorporated herein by reference in its entirety.

### TECHNICAL FIELD

The present disclosure generally relates to a headrest apparatus, and more particularly to a headrest apparatus and method for providing surround sound experience to a user.

### BACKGROUND

With advancements in field of signal processing, various types of audio signals have been utilized for processing. Such types of audio signals include, for example, a mono sound, a stereo sound, and a surround sound. The mono sound refers to a type of sound in which an audio may be received from a single channel only. As the mono sound is being produced from a single source, it may not split up into different channels. Furthermore, the stereo sound makes use of two channels to produce the sound, which makes it appear as if the sound may be coming from two different sources (say left and right). Moreover, the surround sound may be a type of sound that makes use of multiple channels to provide a listener with a more immersive audio experience.

It may be noted that, with the advancements in the field of signal processing, noise cancellation techniques have also emerged rapidly. The noise cancellation corresponds to a technology that allows a suppression or an elimination of unwanted acoustic sound or noise from the audio signals. For example, noise-canceling headphones that may utilize the noise cancellation techniques are already present in market at different prices and are popular among users.

Nowadays, employees working in offices and corporate workspaces face the issue of being exposed to acoustic noises, especially in an open office environment. Sources such as ringing phones, loud office machines, conversations, generators, and air conditioning systems contribute to such noises. This leads to a decrease in the overall focus and concentration of the employees on their respective work, thereby causing a decrease in productivity of the offices as a whole. A straightforward solution to this problem can be wearing the noise cancellation headphones. However, these noise-cancelling headphones are not suitable for office use since they are uncomfortable for long durations of usage. Moreover, long usage of such noise-cancelling headphones may cause various health issues, such as ear fatigue, hearing loss, and damage to the earlobe. Therefore, there is a requirement for an improved headrest apparatus that may be utilized to overcome the challenges in the existing solutions.

### BRIEF SUMMARY

A headrest apparatus, a method, and a computer program product are provided herein that focuses on providing surround sound experience to a user.

In one aspect, a headrest apparatus for providing surround sound experience to a user is disclosed. The headrest apparatus includes a first audio rendering device embedded at a first position in the headrest apparatus, and a second audio rendering device embedded at a second position in the headrest apparatus. The headrest apparatus further includes a processor and a memory coupled to the processor. The memory may be configured to store a plurality of processor-executable instructions. The processor may be configured to execute the plurality of processor-executable instructions. The processor may be configured to receive an audio portion of a media content from an electronic device. The processor may be further configured to determine a plurality of audio channel signals from the received audio portion. The determined plurality of audio channel signals may include at least a first set of audio channel signals that may correspond to a set of rear audio channel signals of the audio portion. The processor may be further configured to control the first audio rendering device to output a first audio channel signal of the first set of audio channel signals. The processor may be further configured to control the second audio rendering device to output a second audio channel signal of the first set of audio channel signals.

In additional apparatus embodiments, the processor may be configured to transmit a control command to the electronic device. The electronic device may be configured to control a set of audio rendering devices associated with the electronic device, to output a second set of audio channel signals of the plurality of audio channel signals based on the transmitted control command.

In additional apparatus embodiments, the second set of audio channel signals may correspond to a set of front audio channel signals.

In additional apparatus embodiments, the received media content may correspond to one of an audio content, a video content, a gaming content, or a meeting content.

In additional apparatus embodiments, the headrest apparatus may further include a first audio capture device and the processor may be configured to control the first audio capture device to capture a voice signal associated with a voice of a user associated with the headrest apparatus. The processor may be further configured to transmit the captured voice signal to the electronic device.

In additional apparatus embodiments, the headrest apparatus may further include a second audio capture device and the processor may be configured to control the second audio capture device to capture a noise signal. The captured noise signal may be associated with a noise within a pre-determined distance of the headrest apparatus. The processor may be further configured to generate an anti-noise signal based on the captured noise signal. A phase of the generated anti-noise signal may be opposite with respect to a phase of the captured noise signal. The processor may be further configured to combine the captured noise signal, the generated anti-noise signal, and at least one of the first audio channel signal or the second audio channel signal to create a noise-free signal. The processor may be further configured control at least the first audio rendering device or the second audio rendering device to output the created noise-free signal.

In additional apparatus embodiments, the headrest apparatus may further include a set of control interfaces. The processor may be further configured to communicate with the set of control interfaces to control at least one of a power supply to the headrest apparatus, a power supply to at least one of a first audio capture device or a second audio capture device, a network connection between the headrest apparatus and the electronic device, a playback of the first set of audio channel signals, one or more audio signal parameters associated with the first set of audio channel signals, and one or more audio rendering device parameters associated with at least one of the first audio rendering device and the second audio rendering device.

In additional apparatus embodiments, the one or more audio signal parameters may include at least one of a bandwidth associated with the first set of audio channel signals, a nominal level associated with the first set of audio channel signals, a bit rate associated with the first set of audio channel signals, a power level associated with the first set of audio channel signals, and a voltage level associated with the first set of audio channel signals.

In additional apparatus embodiments, the one or more audio rendering device parameters may include at least one of a volume associated with at least one of the first audio rendering device or the second audio rendering device, a bass associated with at least one of the first audio rendering device or the second audio rendering device, and a treble associated with at least one of the first audio rendering device or the second audio rendering device.

In additional apparatus embodiments, the headrest apparatus may be attached to a seating apparatus.

In additional apparatus embodiments, the determined plurality of audio channel signals further may include a third set of audio channel signals. The third set of audio channel signals may correspond to a set of center audio channel signals.

In another aspect, a method for providing surround sound experience to user is disclosed is provided. The method may be implemented by a headrest apparatus and may include receiving an audio portion of a media content from an electronic device. The method further includes determining a plurality of audio channel signals from the received audio portion. The determined plurality of audio channel signals includes at least a first set of audio channel signals that may correspond to a set of rear audio channel signals of the audio portion. The method further includes controlling a first audio rendering device, embedded at a first position in the headrest apparatus, to output a first audio channel signal of the first set of audio channel signals. The method further includes controlling a second audio rendering device, embedded at a second position in the headrest apparatus, to output a second audio channel signal of the first set of audio channel signals.

In additional method embodiments, the method includes transmitting a first command to the electronic device. The electronic device may be configured to control a set of audio rendering devices associated with the electronic device to output a second set of audio channel signals of the plurality of audio channel signals.

In additional method embodiments, the received media content may correspond to one of an audio content, a video content, a gaming content, or a meeting content.

In additional method embodiments, the method includes controlling a first audio capture device to capture a voice signal associated with a voice of a user associated with the headrest apparatus. The method further includes transmitting the captured voice signal to the electronic device.

In additional method embodiments, the method includes controlling a second audio capture device to capture a noise signal. The captured noise signal may be associated with a noise within a pre-determined distance of the headrest apparatus. The method further includes generating an anti-noise signal based on the captured noise signal. A phase of the generated anti-noise signal may be opposite with respect to a phase of the captured noise signal. The method further includes combining the captured noise signal, the generated anti-noise signal, and at least one of the first audio channel signal or the second audio channel signal to create a noise-free signal. The method further includes controlling at least the first audio rendering device or the second audio rendering device to output the created noise-free signal.

In additional method embodiments, the determined plurality of audio channel signals may further include a third set of audio channel signals. The third set of audio channel signals may correspond to a set of center audio channel signals.

In yet another aspect, a computer program product including a non-transitory computer readable medium having stored thereon computer executable instructions which when executed by at least one processor, cause the processor to conduct operations for providing surround sound experience to user. The operations may include receiving an audio portion of a media content from an electronic device. The operations may further include determining a plurality of audio channel signals from the received audio portion. The determined plurality of audio channel signals may include at least a first set of audio channel signals that may correspond to a set of rear audio channel signals of the audio portion. The operations may further include controlling a first audio rendering device, embedded at a first position in the headrest apparatus, to output a first audio channel signal of the first set of audio channel signals. The operations may further include controlling a second audio rendering device, embedded at a second position in the headrest apparatus, to output a second audio channel signal of the first set of audio channel signals.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 is a block diagram that illustrates an exemplar network environment for providing surround sound experience to a user, in accordance with an embodiment of the disclosure.

FIG. 2 is a block diagram of a headrest apparatus for providing surround sound experience to a user, in accordance with an embodiment of the disclosure.

FIG. 3 is a block diagram that illustrates exemplar operations for providing surround sound experience to the user, in accordance with an embodiment of the disclosure.

FIG. 4 is a block diagram that illustrates exemplar operations for noise cancellation in an environment around the headrest apparatus, in accordance with an embodiment of the disclosure.

FIG. 5 depicts an exemplar diagram for determination of a plurality of audio channel signals and transmitting the plurality of audio channel signals to a corresponding audio rendering device, in accordance with an embodiment of the disclosure.

FIG. 6 is a diagram that illustrates an exemplar scenario for providing surround sound experience to the user, in accordance with an embodiment of the disclosure.

FIG. 7 is a diagram of that depicts a back view of the headrest apparatus positioned with respect to a head of a seating apparatus for providing surround sound experience to the user, in accordance with some embodiment of the disclosure.

FIG. 8 is a diagram of that depicts the headrest apparatus attached to the seating apparatus, in accordance with some embodiment of the disclosure.

FIG. 9 is a flowchart that illustrates an exemplar method for providing surround sound experience to the user, in accordance with some embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

In comparison with the traditional techniques known in the art, one potential benefit of the disclosed headrest apparatus is the elimination of the need for a headphone. Traditional headphone can cause various health issues, such as hearing loss, ear fatigue, and damage to the earlobe. By utilizing the disclosed headrest apparatus, users may enjoy an immersive surround sound experience without the need for direct contact of the headphone with their cars, thereby reducing the risk of these health issues associated with prolonged use of the headphone.

Moreover, the disclosed headrest apparatus may further promote a safer audio experience by eliminating a need to increase up volume to overcome external noise. The audio rendering devices (i.e., speakers) integrated into the headrest apparatus provide a close and personalized audio experience, ensuring that the user enjoy their media content without exposing their cars to excessively high volume levels. This can help mitigate the risk of noise-induced hearing loss and allows users to maintain a safer listening environment.

Also, the disclosed headrest apparatus integrates connectivity features (such as a Bluetooth® connectivity) that may enable a wireless streaming from external devices such as smartphones, tablets, laptops, or gaming consoles. This connectivity feature further enhances a user convenience and eliminates the potential entanglement and discomfort caused by the headphones. Therefore, the disclosed headrest apparatus enhances an overall listening experience of the user.

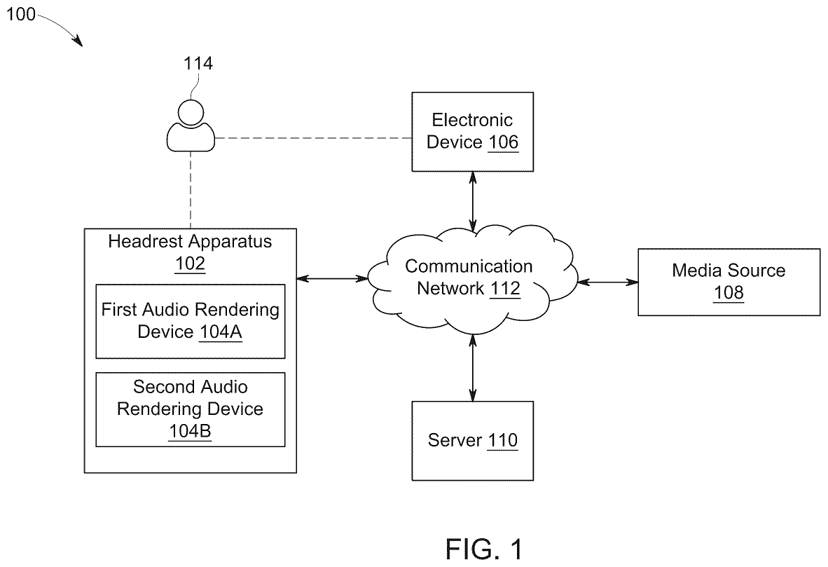

FIG. 1 is a block diagram that illustrates an exemplar network environment 100 for providing surround sound experience to a user, in accordance with an embodiment of the disclosure. With reference to FIG. 1, there is shown the network environment 100. The network environment 100 may include a headrest apparatus 102. The headrest apparatus 102 may include at least a first audio rendering device 104A, and a second audio rendering device 104B. There is further shown an electronic device 106, a media source 108, a server 110, and a communication network 112. With reference to FIG. 1, there is further shown a user 114 associated with the headrest apparatus 102 and the electronic device 106.

The headrest apparatus 102 may include suitable logic, circuitry, interfaces, and/or code that may be configured to receive an audio portion of a media content from the electronic device 106. The headrest apparatus 102 may be further configured to determine a plurality of audio channel signals from the received audio portion of the received media content. The determined plurality of audio channel signals may include at least a first set of audio channel signals corresponding to a set of rear audio channel signals of the audio portion. The headrest apparatus 102 may be further configured to control the first audio rendering device 104A to output a first audio channel signal of the first set of audio channel signals. The headrest apparatus 102 may further be configured to control the second audio rendering device 104B to output a second audio channel signal of the first set of audio channel signals.

The first audio rendering device 104A and the second audio rendering device 104B may include suitable logic, circuitry, and interfaces that may be configured to reproduce or playback the audio portion included in the media content. In an embodiment, the first audio rendering device 104A may be further configured to reproduce the first audio channel signal of the first set of audio channel signals corresponding to a set of rear audio channel signals of the audio portion. The second audio rendering device 104B may be further configured to reproduce the second audio channel signal of the first set of audio channel signals. Examples of the first audio rendering device 104A and the second audio rendering device 104B may include, but are not limited to, a wireless speaker, a sound bar, a woofer or a sub-woofer, a loudspeaker, and/or other computing device with audio reproduction capabilities.

The electronic device 106 may include suitable logic, circuitry, interfaces, and/or code that may be configured to connect with the headrest apparatus 102. In another embodiment, the electronic device 106 may be configured to transmit the audio portion of the media content to the headrest apparatus 102. Examples of the electronic device 106 may include, but are not limited to, a computing device, a mainframe machine, a server, a computer workstation, a smartphone, a cellular phone, a mobile phone, a gaming device, and a consumer electronic (CE) device.

The media source 108 may comprise suitable logic, circuitry, interfaces, and code that may be configured to transmit the media content to the electronic device 106 and/or the headrest apparatus 102. The media source 108 may be configured to store the media content. Examples of the media source 108 may include, but are not limited to, a computing device, a mainframe machine, a server, a computer workstation, a smartphone, a cellular phone, a mobile phone, a gaming device, and the CE device. Other examples of the media source 108 may include a database.

The server 110 may comprise suitable logic, circuitry, interfaces, and code that may be configured to store the media content. The server 110 may receive a request from the headrest apparatus 102 to retrieve the media content stored in the server 110. The server 110 may be implemented as a cloud server which may execute operations through file transfer, web applications, cloud applications, HTTP requests, repository operations, and the like. Other examples of the server 110 may include, but are not limited to a media server, a file server, a web server, a database server, an application server, a mainframe server, a cloud server, or other types of servers. In one or more embodiments, the server 110 may be implemented as a plurality of distributed cloud-based resources by use of several technologies that are well known to those skilled in the art. A person with ordinary skill in the art will understand that the scope of the disclosure may not be limited to implementation of the server 110 and the headrest apparatus 102 as separate entities. In certain embodiments, the functionalities of the server 110 may be incorporated in its entirety or at least partially in the headrest apparatus 102, without departure from the scope of the disclosure.

The communication network 112 may include a communication medium through which the headrest apparatus 102, the electronic device 106, the media source 108, and the server 110 may communicate with each other. The communication network 112 may be one of a wired connection or a wireless connection. Examples of the communication network 112 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 112 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the headrest apparatus 102 may be utilized by the user 114 who may be sitting on a seating apparatus (such as a chair) to watch or listen to a media content (such as a song or watch a movie on the electronic device 106) in a surround sound environment. The headrest apparatus 102 may be attached with the seating apparatus via a mounting mechanism and may include the first audio rendering device 104A embedded on a left side of the headrest apparatus 102 and a second audio rendering device 104B embedded on a right side of the headrest apparatus 102 when respect to the user 114 siting on the seating apparatus. The headrest apparatus 102 may be connected with the electronic device 106 (say a laptop) via the communication network 112 (say via Bluetooth®). The headrest apparatus 102 may be configured to receive the audio portion of the media content from the electronic device 106 (or the media source 108 or the server 110). In an embodiment, the electronic device 106 may be configured to receive the media content from the media content (such as a video content) from the media source 108 (such as a video streaming platform) and transmit the media content to the headrest apparatus 102.

The headrest apparatus 102 may be further configured to determine a plurality of audio channel signals from the audio portion of the received media content. The determined plurality of audio channel signals may include at least a first set of audio channel signals that may corresponding to a set of rear audio channel signals of the audio portion.

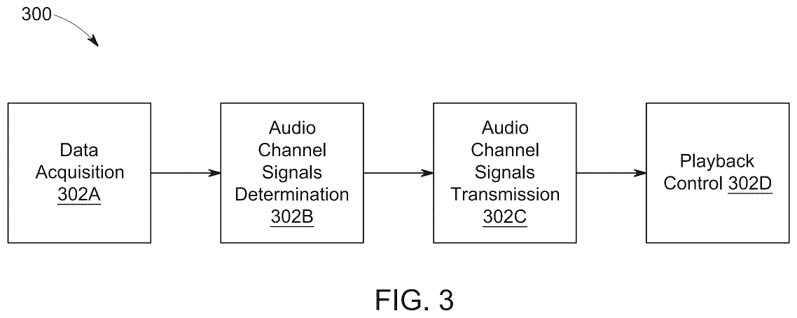

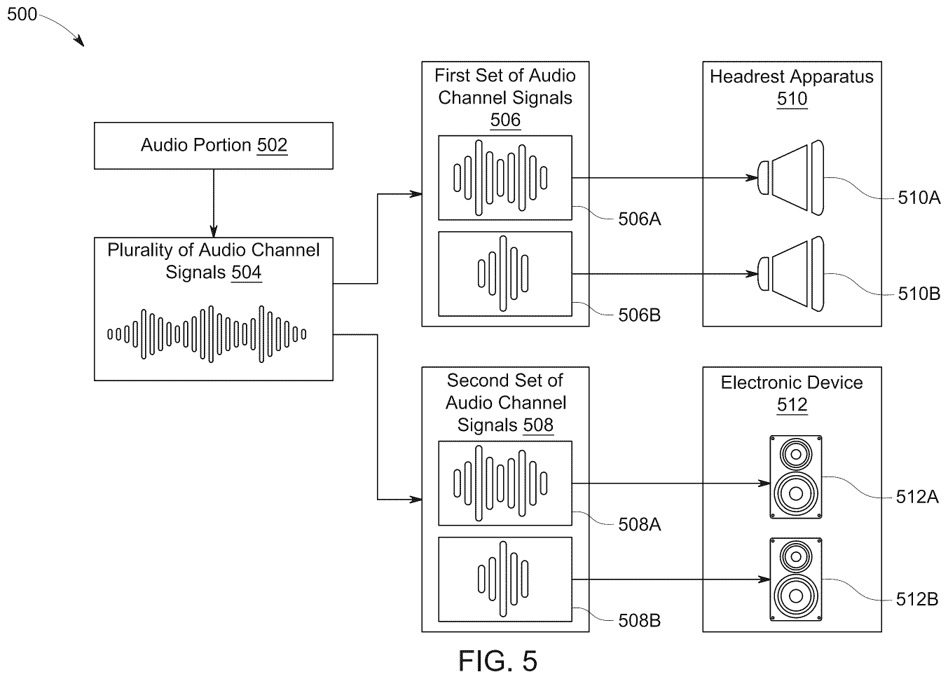

To generate the surround sound environment, the headrest system 102 may be configured to control the first audio rendering device 104A to output a first audio channel signal of the first set of audio channel signals. The first audio rendering device 104A may be disposed at a first position in the headrest apparatus 102. The first position may on a left side of the headrest apparatus 102 when viewed from a backside of the headrest apparatus 102. The headrest system 102 may be configured to control the second audio rendering device 104B to output a second audio channel signal of the first set of audio channel signals. The second audio rendering device 104B may be disposed at a second position in the headrest apparatus 102. The second position may on a right side of the headrest apparatus 102 when viewed from the backside of the headrest apparatus 102. Details about the first set of audio channel signals are provided, for example, in FIG. 3, and FIG. 5.

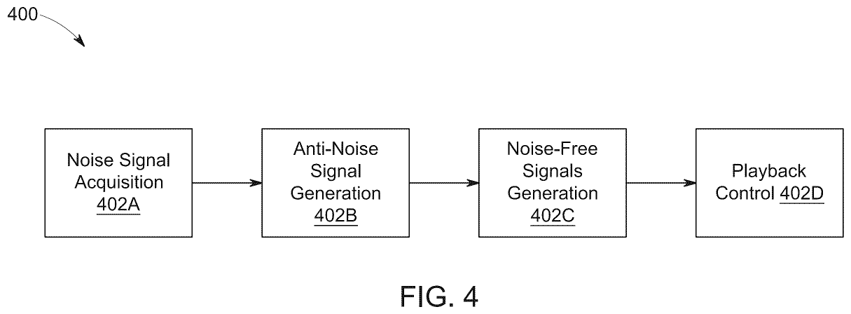

In some other embodiment, the headrest apparatus 102 may be able to suppress (or cancel) noise signals associated with a noise within a pre-determined distance of the headrest apparatus 102. Details about suppression (or the cancellation) of noise signals are provided, for example, in FIG. 4.

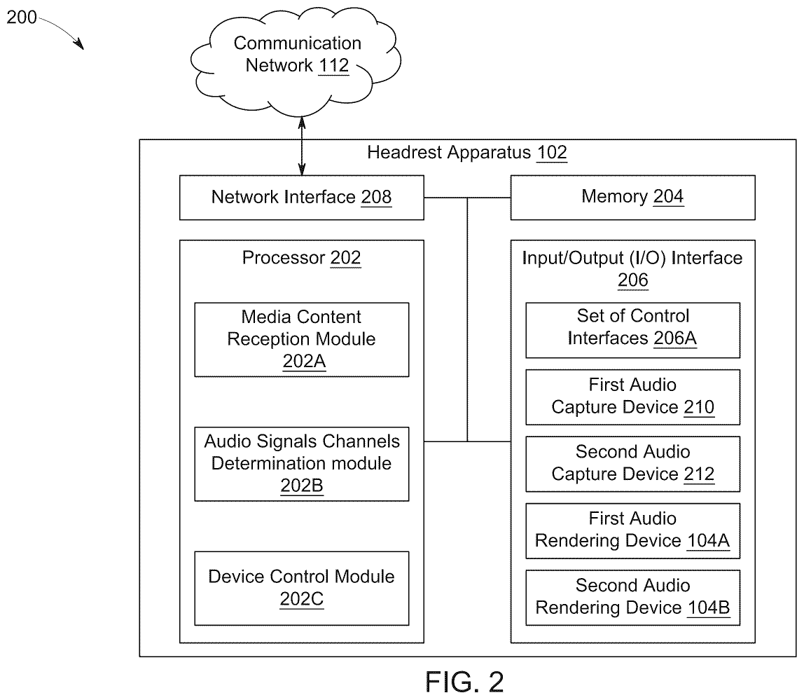

FIG. 2 is a block diagram of the headrest apparatus 102 of FIG. 1, in accordance with an embodiment of the disclosure. FIG. 2 is explained in conjunction with elements from FIG. 1. With reference to FIG. 2, there is shown a block diagram 200 of the headrest apparatus 102. The headrest apparatus 102 may include a processor 202, a memory 204, an input/output interface 206, a network interface 208, a first audio capture device 210, and a second audio capture device 212. The input/output interface 206 may include a set of control interfaces 206A. The processor may include a media content reception module 202A, an audio signals channels determination module 202B, and a device control module 202C. The processor 202 may be communicatively coupled to the memory 204, the input/output interface 206, the network interface 208, the first audio capture device 210, the second audio capture device 212, the first audio rendering device 104A, and the second audio rendering device 104B.

The processor 202 may include suitable logic, circuitry, and/or interfaces that may be configured to execute program instructions associated with different operations to be executed by the headrest apparatus 102. The processor 202 may include one or more specialised processing units, which may be implemented as an integrated processor or a cluster of processors that perform the functions of the one or more specialized processing units, collectively. The processor 202 may be implemented based on a number of processor technologies known in the art. Examples of implementations of the processor 202 may be an x86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other computing circuits.

The media content reception module 202A m may include suitable logic, circuitry, and/or interfaces that may be configured to receive an audio portion of a media content. The media content reception module 202A may be configured to receive the audio portion of a media content from the electronic device 106. In another embodiment, the media content reception module 202A may be configured to receive the audio portion of a media content from the media source 108 (and/or the server 110). Details about the media content reception module 202A and the media content are provided, for example, in FIG. 3.

The audio signals channels determination module 202B may include suitable logic, circuitry, and/or interfaces that may be configured to determine a plurality of audio channel signals from the received audio portion. The determined plurality of audio channel signals may include at least a first set of audio channel signals corresponding to a set of rear audio channel signals of the audio portion. In another embodiment, the determined plurality of audio channel signals may include the second set of audio channel signals and a third set of audio channel signals. Details about the audio signals channels determination module 202B and the plurality of audio channel signals are provided, for example, in FIG. 3.

The device control module 202C may include suitable logic, circuitry, and/or interfaces that may be configured to control the first audio rendering device 104A to output the first audio channel signal of the first set of audio channel signals. The device control module 202C may be further configured to control the second audio rendering device 104B to output a second audio channel signal of the first set of audio channel signals. In some other embodiments, the device control module 202C may be further configured to control the first audio capture device 210 to capture a voice signal and the first audio capture device 212 to capture a noise signal. Details about the device control module 202C, the first audio channel signal, the second audio channel signal, the voice signal, and the noise signal are provided, for example, in FIG. 3, FIG. 4, and FIG. 5.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 201). The memory 204 may be configured to store information, data, content, applications, instructions, or the like, for enabling the apparatus to carry out various functions in accordance with an example embodiment of the present invention. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present invention while configured accordingly. Thus, for example, when the processor 202 is embodied as an ASIC, FPGA or the like, the processor 202 may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present invention by further configuration of the processor 202 by instructions for performing the algorithms and/or operations described herein. The processor 202 may include, among other things, a clock, an arithmetic logic unit (ALU) and logic gates configured to support operation of the processor 202. Examples of implementations of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The input/output (I/O) interface 206 may include suitable logic, circuitry, interfaces, and/or code that may be configured to receive an input and provide an output based on the received input. The I/O interface 206 may include various input and output devices, which may be configured to communicate with the processor 202. For example, the headrest apparatus 102 may receive set of user inputs via the I/O interface 206. The I/O interface 206 may comprise various input and output devices, which may be configured to communicate with different operational components of the headrest apparatus 102. Examples of the I/O interfaces 206 may include, but are not limited to, a touch screen, a hardware button, a keyboard, a mouse, a joystick, a microphone, and a display screen. Other examples of the I/O interfaces 206 may include, but are not limited to, the first audio rendering device 104A, the second audio rendering device 104B, the first audio capture device 210, and the second audio capture device 212.

The set of control interfaces 206A may be used to receive the set of user inputs from the user 114. In an embodiment, each control interface of the set of control interfaces 206A may be a hardware button (such as a light emitting diode (LED) button) or a hardware knob. In another embodiment, the set of control interfaces 206A may be a user interface element that may displayed on a display screen installed within the headrest apparatus 102 or the electronic device 106.

In an embodiment, the processor 202 may be configured to communicate with the set of control interfaces 206A to control at least one of a power supply to the headrest apparatus 102, a power supply to at least one of the first audio capture device 210 or the second audio capture device 212, a network connection between the headrest apparatus 102 and the electronic device 106, a playback of the first set of audio channel signals, one or more audio signal parameters associated with the first set of audio channel signals, and one or more audio rendering device parameters associated with at least one of the first audio rendering device 104A and the second audio rendering device 104B.

The controlling of the power supply to the headrest apparatus 102 may correspond to controlling a supply of first voltage that may be provided to the headrest apparatus 102 to perform corresponding operations. Similarly, the controlling of the power supply to the first audio capture device 210 or the second audio capture device 212 may correspond to controlling a supply of a second voltage that may be provided to the to the first audio capture device 210 or the second audio capture device 212 to perform corresponding operations of capturing the voice signal and capturing the noise signal. The controlling of the network connection between the headrest apparatus 102 and the electronic device 106 may correspond to pairing and establishing communication between the headrest apparatus 102 and the electronic device 106 (such as a Bluetooth® connection). The controlling of the playback of the first set of audio channel signals may correspond to controlling the output of the at least one of the first audio rendering device 104A and the second audio rendering device 104B.

In an embodiment, the one or more audio signal parameters associated with the first set of audio channel signals may include at least one of a bandwidth associated with the first set of audio channel signals, a nominal level associated with the first set of audio channel signals, a bit rate associated with the first set of audio channel signals, a power level associated with the first set of audio channel signals, and a voltage level associated with the first set of audio channel signals.

The bandwidth associated with the first set of audio channel signals may correspond to a range of frequencies within the first set of audio channel signals. The nominal level associated with the first set of audio channel signals may correspond to an average or an intended power or volume level at which the first set of audio channel signals may meant to be heard or recorded. The bit rate associated with the first set of audio channel signals may correspond to a number of bits per unit of time used to represent the first set of audio channel signals. The power level associated with the first set of audio channel signals may correspond to a measure the amount of electrical power carried by the first set of audio channel signals. The voltage level associated with the first set of audio channel signals may correspond to an amplitude or a strength of an electrical signal that represents the first set of audio channel signals. In an embodiment, the set of control interfaces 206A may be utilized by the user 114 to control each of the one or more audio signal parameters associated with the first set of audio channel signals.

In an embodiment, the one or more audio rendering device parameters may include at least one of a volume associated with at least one of the first audio rendering device 104A or the second audio rendering device 104B, a bass associated with at least one of the first audio rendering device 104A or the second audio rendering device 104B, and a treble associated with at least one of the first audio rendering device 104A or the second audio rendering device 104B.

The volume associated with at least one of the first audio rendering device 104A or the second audio rendering device 104B may correspond to a sound level that at least one of the first audio rendering device 104A or the second audio rendering device 104B may be able to produce without any distortion. The bass associated with at least one of the first audio rendering device 104A or the second audio rendering device 104B may correspond to a capability of the first audio rendering device 104A or the second audio rendering device 104B to produce low-frequency audio signals up to 200 Hz. The treble associated with at least one of the first audio rendering device 104A or the second audio rendering device 104B may correspond to a capability of the first audio rendering device 104A or the second audio rendering device 104B to produce high-frequency audio signals ranging from 6 kHz to 20 KHz. In an embodiment, the set of control interfaces 206A may be utilized by the user 114 to control each of the one or more audio rendering device parameters associated with at least one of the first audio rendering device 104A or the second audio rendering device 104B.

The network interface 208 may include suitable logic, circuitry, interfaces, and/or code that may be configured to establish communication between the headrest apparatus 102, the electronic device 106, the media source 108, and the server 110, via the communication network 112. The network interface 208 may be configured to implement known technologies to support wired or wireless communication. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 208 may be configured to communicate via offline and online wireless communication with networks, such as the Internet, an Intranet, and/or a wireless network, such as a cellular telephone network, a wireless local area network (WLAN), personal area network, and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), LTE, time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VOIP), Wi-MAX, Internet-of-Things (IoT) technology, Machine-Type-Communication (MTC) technology, a protocol for email, instant messaging, and/or Short Message Service (SMS).

The first audio capture device 210 may include suitable logic, circuitry, and/or interfaces that may be configured to capture a voice signal associated with a voice of the user 114. The first audio capture device 210 may be further configured to convert the captured voice signal into an electrical signal. In an embodiment, the first audio capture device 210 may be a mono-microphone integrated within the headrest apparatus 102. Examples of the first audio capture device 210 may include, but are not limited to, a recorder, an electret microphone, a dynamic microphone, a carbon microphone, a piezoelectric microphone, a fiber microphone, a (micro-electro-mechanical systems) MEMS microphone, or other microphones known in the art.

The second audio capture device 212 may include suitable logic, circuitry, and/or interfaces that may be configured to capture one or more noise signals. The second audio capture device 212 may be further configured to convert the captured one or more noise signals into one or more electrical signals. In an embodiment, the second audio capture device 212 may be a mono-microphone integrated within the headrest apparatus 102. Examples of the second audio capture device 212 may include, but are not limited to, a recorder, an electret microphone, a dynamic microphone, a carbon microphone, a piezoelectric microphone, a fiber microphone, a (micro-electro-mechanical systems) MEMS microphone, or other microphones known in the art.

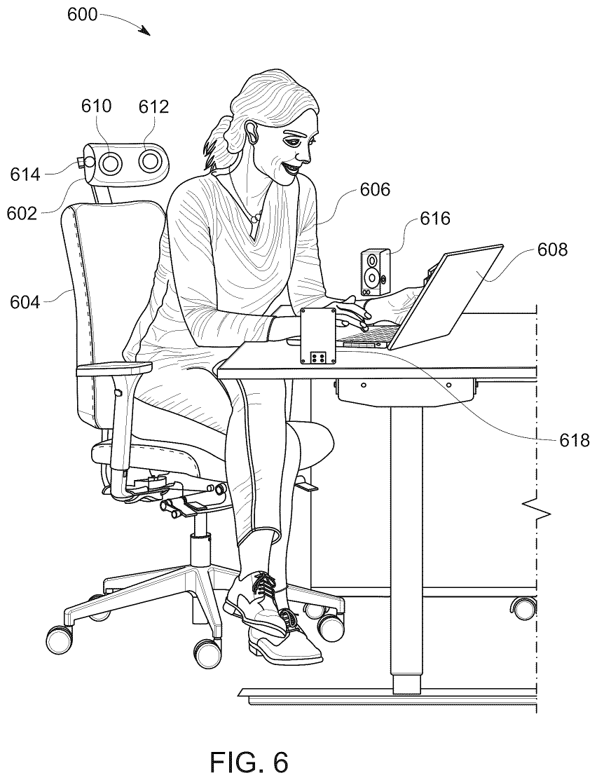

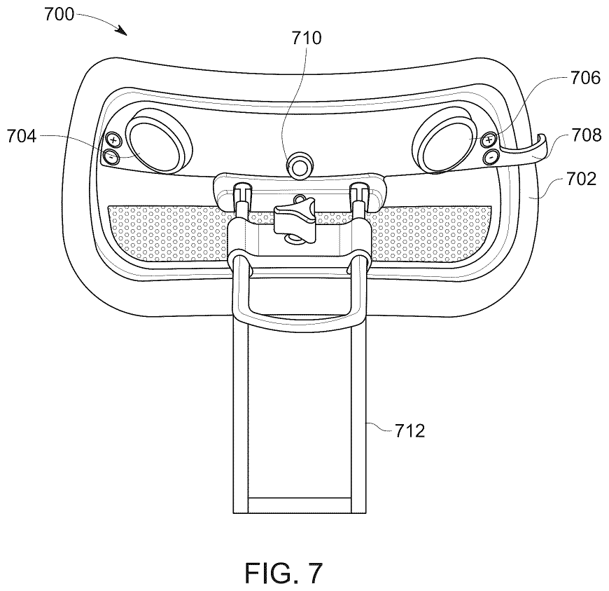

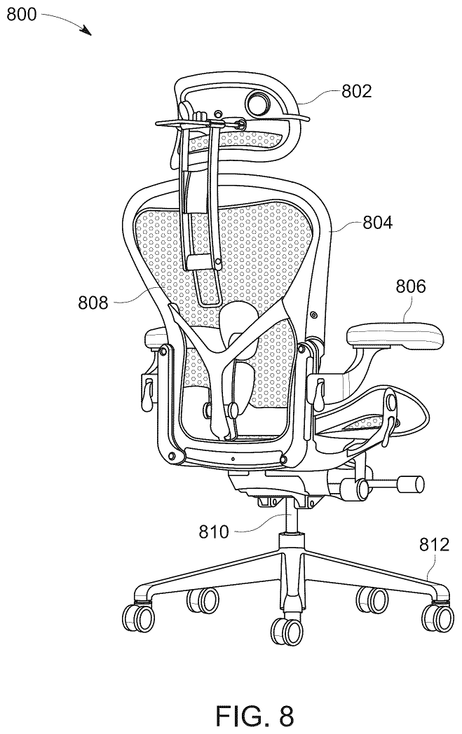

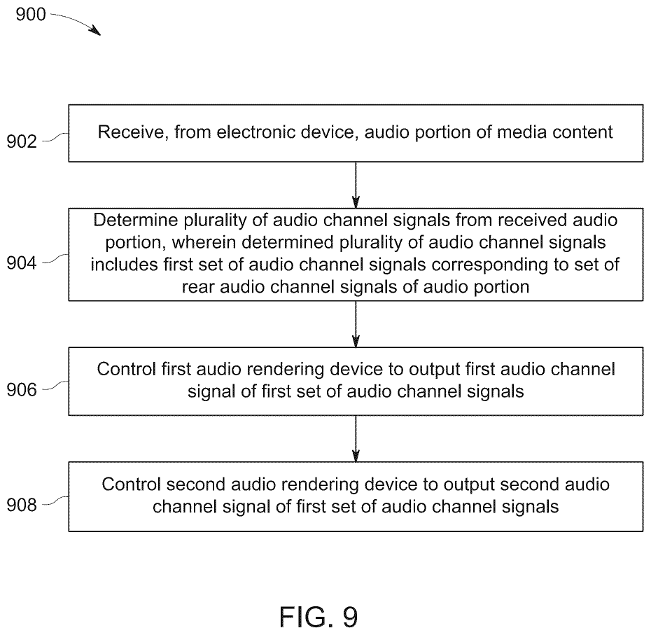

The functions or operations executed by the headrest apparatus 102, as described in FIG. 1, may be performed by the processor 202. Operations executed by the processor 202 are described in detail, for example, in FIG. 3, FIG. 4, FIG. 5, FIG. 6, FIG. 7, FIG. 8, and FIG. 9.

FIG. 3 is a block diagram 300 that illustrates exemplar operations for providing surround sound experience to user, in accordance with an embodiment of the disclosure. FIG. 3 is explained in conjunction with elements from FIG. 1, and FIG. 2. With reference to FIG. 3, there is shown the block diagram 300 that illustrates exemplar operations from 302A to 302D, as described herein. The exemplar operations illustrated in the block diagram 300 may start at 302A and may be performed by any computing system, apparatus, or device, such as by the headrest apparatus 102 of FIG. 1 or the processor 202 of FIG. 2. Although illustrated with discrete blocks, the exemplar operations associated with one or more blocks of the block diagram 300 may be divided into additional blocks, combined into fewer blocks, or eliminated, depending on the particular implementation.

At step 302A, a data reception operation may be performed. In the data reception operation, the processor 202 may be configured to receive an audio portion of media content. In an embodiment, the headrest apparatus 102 may be utilized by the user 114 who may be sitting on a seating apparatus (such as a chair) to watch or listen to a media content (such as a song or watch a movie on the electronic device 106) in a surround sound environment. The headrest apparatus 102 may be attached with the seating apparatus via a mounting mechanism and may include the first audio rendering device 104A embedded on a left side of the headrest apparatus 102 and a second audio rendering device 104B embedded on a right side of the headrest apparatus 102 when respect to the user 114 siting on the seating apparatus.

In an embodiment, the media content may correspond to one of an audio content, a video content, a gaming content, or a meeting content. Every media content may include at least the audio portion. The audio content may correspond to one of a speech, a music, a sound effect, and the like. The video content may correspond to one of a video, and a podcast. The gaming content may correspond to an audio-visual content associated with a gaming application. The meeting content may correspond to an audio-visual content (or the audio content) associated with a meeting, a conference or any other virtual meeting application.

In an embodiment, the audio portion of the media content may be received from the electronic device 106. In an alternate embodiment, the audio portion of the media content may be received from at least one of the media source 108, or the server 110. In another alternate embodiment, the electronic device 106 may be configured to receive the media content from the media content (such as a video content) from the media source 108 (such as a video streaming platform) and transmit the media content to the headrest apparatus 102. In an embodiment, the operation described at step 302A may be executed by the media content reception module 202A.

At step 302B, an audio channel signals determination operation may be performed. In the audio channel signals determination operation, the processor 202 may be configured to determine a plurality of audio channel signals. Each audio channel of the plurality of audio channel signals may correspond to an individual stream of a recorded sound wave with a location in a sound field. The sound field may refer to an acoustic space where the sound wave may propagate, typically within an enclosed or semi-enclosed area. Alternatively, the audio channel signal may be a communication pathway for the sound wave. The audio channel signal may be a representation of the sound wave coming from or going to a single point.

In an embodiment, the determined plurality of audio channel signals may include a first set of audio channel signals, and a second set of audio channel signals. In another embodiment, the determined plurality of audio channel signals may further include a third set of audio channel signals. The first set of audio channel signals may correspond to a set of rear audio channel signals. Each of the set of rear audio channel signals may be rendered through the first audio rendering device 104A and the second audio rendering device 104B that may be placed at a rear location with respect to the user 114 (behind the user 114) sitting on the seating apparatus to provide a surround sound experience to the user 114. In an embodiment, the first set of audio channel signals may include at least a first audio channel signal and a second audio channel signal. Specifically, the first audio channel signal may be a rear left audio channel signal that may be rendered through the first audio rendering device 104A that may be placed on a left side of the headrest apparatus 102 when viewed from a back side. Similarly, the second audio channel signal may be a rear right audio channel signal that may be rendered through the second audio rendering device 104B that may be placed on a right side of the headrest apparatus 102 when viewed from the back side. Details about the placement of the first audio rendering device 104A and the second audio rendering device 104B are provided, for example, in FIG. 6 and FIG. 7.

The second set of audio channel signals may correspond to a set of front audio channel signals. Each of the set of front audio channel signals may be rendered through an audio rendering device that may be placed in front of to the user 114 to provide the surround sound experience to the user 114. In an embodiment, the second set of audio channel signals may include at least a first audio channel signal and a second audio channel signal. Specifically, the first audio channel signal may be a front left audio channel signal that may be rendered through a first audio rendering device of the set of audio rendering devices associated with the electronic device 106 (such as the laptop). The first audio rendering device may be placed on a left side of the electronic device 106. Similarly, the second audio channel signal may be a front right audio channel signal that may be rendered through a second audio rendering device of the set of audio rendering devices associated with the electronic device 106. The second audio rendering device may be placed on a right side of the electronic device 106. Details about the front audio channel signals, the first audio rendering device, and the second audio rendering device associated with the electronic device 106 are provided, for example, in FIG. 5 and FIG. 6.

In an embodiment, each of the second set of audio channel signals may correspond to an audio signal associated with main soundstage and focused sounds (i.e., high, and mid-range audio frequencies), such as a dialogue, and a directionality of instruments in a musical piece. In an embodiment, each of the first set of audio channel signals may correspond to an audio signal associated with ambient sounds (i.e., mid-range and low-frequency audio frequencies) like crowd noise, and sound effects that surround the user 114, adding depth to the overall audio experience. In another embodiment, the first set of audio channel signals may be same as the second set of audio channel signals but may have an opposite phase with respect to each other.

The third set of audio channel signals may correspond to a set of center audio channel signals. Each of the set of centre audio channel signals may be rendered through the audio rendering device (such as a speaker) that may be placed at a front-center with respect to the user 114 to provide the surround sound experience to the user 114. In another embodiment, the audio rendering device that may be placed at a rear-centre location with respect to the user 114. In an embodiment, the third set of audio channel signals may include at least a first audio channel signal. Specifically, the first audio channel signal may be a center audio channel signal that may be rendered through the audio rendering device may be placed at the front-center with respect to the user 114 (or at the rear-center with respect to the user 114) and associated with the electronic device 106 or the headrest apparatus 102.

On the other hand, rear audio channels are located at the back of the audio setup. They are generally used to enhance the overall sound experience and provide a more atmospheric output. Rear channels are commonly used for ambient and background sounds that help set the mood of a film or the game. They are responsible for creating the illusion of depth and space, which is why they are also called surround sound channels. In summary, front audio channels provide a more directional and focused sound experience, while rear channels are used to create a more immersive and spatial environment. Both channels are crucial to achieving a premium audio experience.

In an embodiment, the plurality of audio channel signals may be determined from the received audio portion based on an application of one or more signal processing techniques. Such one or more signal processing techniques are already known the art and description of each of the one or more signal processing techniques have been omitted for the sake of brevity. In an embodiment, the operation described at step 302B may be executed by the audio signals channels determination module 202B.

At step 302C, an audio channel signals transmission operation may be performed. In the audio channel signals transmission operation, the processor 202 may be configured to transmit each of the determined plurality of the audio channel signals to the corresponding audio rendering device. In an embodiment, the first set of audio channel signals may be transmitted to a first set of audio rendering devices embedded within the headrest apparatus 102. The second set of audio channel signals may be transmitted to a second set of audio rendering devices associated with the electronic device 106 that may be communicatively coupled with the headrest apparatus 102 via the communication network 112. Similarly, the third set of audio channel signals may be transmitted to a third set of audio rendering devices associated with the electronic device 106 and/or the headrest apparatus 102. Details about the audio channel signals transmission operation are provided, for example, in FIG. 5.

At step 302D, a playback control operation may be performed. In the playback control operation, the processor 202 may be configured to control the first audio rendering device 104A positioned at the left side (i.e. the first position) of the headrest apparatus 102 to output the first audio channel signal of the first set of audio channel signals. The processor 202 may be further configured to control the second audio rendering device 104B positioned at the right side (i.e., the second position) of the headrest apparatus 102 to output the second audio channel signal of the first set of audio channel signals.

In another embodiment, the processor 202 may be further configured to transmit a first control command to the electronic device 106. Based on the transmitted first control command, the electronic device 106 may be configured to control the second set of audio rendering devices associated with the electronic device 106 to output the second set of audio channel signals of the plurality of audio channel signals. Specifically, the electronic device 106 may be configured to control the first audio rendering device of the second set of audio rendering devices positioned at the left side of the electronic device 106 to output the first audio channel signal of the second set of audio channel signals based on the transmitted first control command. The electronic device 106 may be configured to control the second audio rendering device of the second set of audio rendering devices positioned at the right side of the electronic device 106 to output the second audio channel signal of the second set of audio channel signals based on the transmitted first control command.

Similarly, the processor 202 may be further configured to transmit a second control command to the third set of audio rendering devices associated with at least one of the headrest apparatus 102 or the electronic device 106. Based on the transmitted third control command, the headrest apparatus 102 and/or the electronic device 106 may be configured to control the third set of audio rendering devices to output the third set of audio channel signals of the plurality of audio channel signals. Details about the playback control operation are provided, for example, in FIG. 5, and FIG. 6.

In an embodiment, the audio portion may include only one audio channel signal (in case of mono stereo). In such a scenario, the disclosed headrest apparatus 102 may be configured to control at least one of the first audio rendering device 104A or the second audio rendering device 104B to output the audio channel signal. In another embodiment, the audio portion may include only two audio channel signals (in case of stereo). The two audio channel signals may correspond to a left audio channel signal and a right audio channel signal. In such a scenario, the headrest apparatus 102 may be configured to control the first audio rendering device 104A to output the left audio channel signal. The headrest apparatus 102 may be configured to control the second audio rendering device 104B to output the right audio channel signal. In an embodiment, the operation described at step 302D may be executed by the device control module 202C.

FIG. 4 is a block diagram 400 that illustrates exemplar operations for noise cancellation in an environment of the headrest apparatus 102, in accordance with an embodiment of the disclosure. FIG. 4 is explained in conjunction with elements from FIG. 1, FIG. 2, and FIG. 3. With reference to FIG. 4, there is shown the block diagram 400 that illustrates exemplar operations from 402A to 402D, as described herein. The exemplar operations illustrated in the block diagram 400 may start at 402A and may be performed by any computing system, apparatus, or device, such as by the headrest apparatus 102 of FIG. 1 or the processor 202 of FIG. 2. Although illustrated with discrete blocks, the exemplar operations associated with one or more blocks of the block diagram 400 may be divided into additional blocks, combined into fewer blocks, or eliminated, depending on the particular implementation.

At step 402A, a noise signal acquisition operation may be performed. In the noise signal acquisition operation, the processor 202 may be configured to control the second audio capture device 212 (or the first audio capture device 210) to capture a noise signal. In an embodiment, the user 114 may be sitting in a noisy environment (such in an office, an airport, a lounge, and the like) that may have noise from multiple sources such as, but not limited to, one or more ringing mobile phones, one or more machines, conversations between people, one or more generators, one or more air conditioning systems, and the like. In such an embodiment, the processor 202 may be configured to control the second audio capture device 212 (for e.g. the microphone) to capture the noise signal associated with the noise within a pre-determined distance of the headrest apparatus 102. The captured noise signal may refer to a signal that may be random and may not have a defined pattern or a defined structure. The captured noise signal may be characterized by variations in amplitude and frequency over time, making it difficult to distinguish specific features or patterns within the noise signal.

At step 402B, an anti-noise signal generation operation may be performed. In the anti-noise signal generation operation, the processor 202 may be configured to generate an anti-noise signal. The anti-noise signal may be generated based on the captured noise signal. In an embodiment, the anti-noise signal may be similar to the noise signal but may have an opposite phase. Specifically, the frequency and the amplitude of the generated anti-noise signal may be same as the captured noise signal but the phase of the generated anti-noise signal may be opposite with respect to a phase of the captured noise signal. Details about the anti-noise signal are known in the art and have been omitted for the sake of brevity.

At step 402C, a noise-free signals generation operation may be performed. In the noise-free signals generation operation, the processor 202 may be configured to generate one or more noise-free signals. In an embodiment, the processor 202 may be configured to combine the captured noise signal, the generated anti-noise signal, and the first audio channel signal to create a first noise-free signal. In another embodiment, the processor 202 may be configured to combine the captured noise signal, the generated anti-noise signal, and the second audio channel signal to create a second noise-free signal. By combining, the captured noise signal and the generated anti-noise signal, the noise may be filtered out. In an embodiment, the processor 202 may be configured to combine the captured noise signal, the generated anti-noise signal, along with each signal of the plurality of audio channel signals to create a plurality of noise-free signals that may include the first noise-free signal and the second noise-free signal. In an embodiment, the processor 202 may be configured to combine the captured noise signal, the generated anti-noise signal, and at least one of the first audio channel signal or the second audio channel signal using one or more signal blending technologies known in the art. Details of such one or more signal blending technologies have been omitted for the sake of brevity.

At step 402D, a playback control operation may be performed. In the playback control operation, the processor 202 may be configured to control the first audio rendering device 104A positioned at the left side (i.e., the first position) of the headrest apparatus 102 to output the created first noise-free signal. The processor 202 may be further configured to control the second audio rendering device 104B positioned at the right side (i.e., the second position) of the headrest apparatus 102 to output the second noise-free signal. In an embodiment, the processor 202 may be configured to control each of the first set of audio rendering devices, the second set of audio rendering devices, and the third set of audio rendering devices to output the corresponding noise-free signal of the plurality of noise-free signals. Details about controlling each of the first set of audio rendering devices, the second set of audio rendering devices, and the third set of audio rendering devices are provided, for example, at 304A in FIG. 3.

Therefore, the plurality of noise-free signals, when outputted through the first set of audio rendering devices, the second set of audio rendering devices, and the third set of audio rendering devices may provide a surround sound experience to the user with noise cancellation.

FIG. 5 depicts an exemplar diagram 500 for determination of a plurality of audio channel signals 504 and transmitting the plurality of audio channel signals 504 to a corresponding audio rendering device, in accordance with an embodiment of the disclosure. FIG. 5 is explained in conjunction with elements from FIG. 1, FIG. 2, FIG. 3, and FIG. 4. With reference to FIG. 5, there is shown the exemplar diagram 500. The exemplar diagram 500 may include an audio portion 502 of a media content, the plurality of audio channel signals 504, a first set of audio channel signals 506, and a second set of audio channel signals 508. There is further shown a headrest apparatus 510, and an electronic device 512. The headrest apparatus 510 may be an exemplar embodiment of the headrest apparatus 102 of FIG. 1. Similarly, the electronic device 512 may be an exemplar embodiment of the electronic device 106 of FIG. 1.

The processor 202 may be configured to receive the audio portion 502 that may be included in the media content. The media content may be received from the electronic device 512 and may correspond to one of an audio content, a video content, a gaming content, or a meeting content. The processor 202 may be further configured to determine the plurality of audio channel signals 504 that may be included in the received audio portion 502 of the media content. The determined plurality of audio channel signals 504 may include the first set of audio channel signals 506, and the second set of audio channel signals 508. In an embodiment, the determined plurality of audio channel signals 504 may further include a third set of audio channel signals (not shown).

The first set of audio channel signals 506 may correspond to a set of rear audio channel signals and may include a first audio channel signal 506A and a second audio channel signal 506B. The first audio channel signal 506A may correspond to a rear left audio channel signal and the second audio channel signal 506B may correspond to a rear right audio channel signal. In an embodiment, the first set of audio channel signals 506 may further include a third audio channel signal (not shown). The third audio channel signal may correspond to a rear center audio channel signal.

The second set of audio channel signals 508 may correspond to a set of front audio channel signals. Similar to the first set of audio channel signals 506, the second set of audio channel signals 508 include a first audio channel signal 508A, and a second audio channel signal 508B. The first audio channel signal 508A may correspond to a front left audio channel signal and the second audio channel signal 508B may correspond to a front right audio channel signal. In an embodiment, the second set of audio channel signals 508 may further include a third audio channel signal (not shown). The third audio channel signal may correspond to a front center audio channel signal.

The processor 202 may be further configured to transmit the first audio channel signal 506A of the first set of audio channel signals 506 to a first audio rendering device 510A of the headrest apparatus 510. The first audio rendering device 510A may be disposed at a first location (i.e., on a left side) of the headrest apparatus 510. The processor 202 may be further configured to control the first audio rendering device 510A to output the first audio channel signal 506A. The processor 202 may be further configured to transmit the second audio channel signal 506B of the first set of audio channel signals 506 to a second audio rendering device 510B of the headrest apparatus 510. The second audio rendering device 510B may be disposed at a second location (i.e., on a right side) of the headrest apparatus 510. The processor 202 may be further configured to control the second audio rendering device 510B to output the second audio channel signal 506B.

In an embodiment, the processor 202 may be further configured to transmit the third audio channel signal of the first set of audio channel signals to a third audio rendering device (not shown) of the headrest apparatus 510. The third audio rendering device may be disposed at a third location (i.e., at center) of the headrest apparatus 510. The processor 202 may be further configured to control the third audio rendering device to output the third audio channel signal of the first set of audio channel signals 506.

Similarly, the processor 202 may be further configured to transmit the first audio channel signal 508A of the second set of audio channel signals 508 to a first audio rendering device 512A of the electronic device 512. The first audio rendering device 512A may be disposed at a first location (i.e., on a left side) of the electronic device 512. The processor 202 may be further configured to control the first audio rendering device 512A to output the first audio channel signal 508A. The processor 202 may be further configured to transmit the second audio channel signal 508B of the second set of audio channel signals 508 to a second audio rendering device 512B of the electronic device 512. The second audio rendering device 512B may be disposed at a second location (i.e., on a right side) of the electronic device 512. The processor 202 may be further configured to control the second audio rendering device 512B to output the second audio channel signal 508B. In an embodiment, the processor 202 may be further configured to transmit the third audio channel signal of the second set of audio channel signals to a third audio rendering device (not shown) of the electronic device 512. The third audio rendering device may be disposed at a third location (i.e., at center) of the electronic device 512. The processor 202 may be further configured to control the third audio rendering device to output the third audio channel signal of the second set of audio channel signals 508.

In an embodiment, the processor 202 may be configured to transmit a control command to the electronic device 106. Based on the reception of the control command by the electronic device 106, the electronic device 106 may be configured to control each of the first audio rendering device 512A, the second audio rendering device 512B, and the third audio rendering device to output the corresponding audio channel signal.

FIG. 6 is a diagram that illustrates an exemplar scenario 600 for providing surround sound experience to the user, in accordance with an embodiment of the disclosure. FIG. 6 is explained in conjunction with elements from FIG. 1, FIG. 2, FIG. 3, FIG. 4, and FIG. 5. With reference to FIG. 6, there is shown the exemplar scenario 600 that includes a headrest apparatus 602 that may be detachably attached to a chair 604. There is further shown a user 606 sitting on the chair 604. With respect to the exemplar scenario 600, there is shown a laptop 608 that may be an exemplar embodiment of the electronic device 102. The headrest apparatus 602 includes a first speaker 610, a second speaker 612, and a microphone 614. The first speaker 610 may be an exemplar embodiment of the first audio rendering device 104A, and the second speaker 612 may be an exemplar embodiment of the second audio rendering device 104B. Similarly, the microphone 614 may be an exemplar embodiment of at least one of the first audio capture device 210 or the second audio capture device 212. The first speaker 610, the second speaker 612, and the microphone 614 may be integrated within the headrest apparatus 602. There is further shown a third speaker 616, and a fourth speaker 618 associated with the laptop 608.

The headrest apparatus 602 may be configured to receive the audio portion of the media content. The audio portion of the media content may be received from the laptop 608. Both the headrest apparatus 602 and the laptop 608 may be associated with the user 606. The headrest apparatus 602 may be configured to determine a plurality of audio channel signals from the received audio portion. The determined plurality of audio channel signals comprises at least a first set of audio channel signals and a second set of audio channels.

The headrest apparatus 602 may be further configured to control the first speaker 610 to output a first audio channel signal of the first set of audio channel signals. The headrest apparatus 602 may be further configured to control the second speaker 612 to output a second audio channel signal of the first set of audio channel signals. In an embodiment, the headrest apparatus 602 may be further configured to transmit a control command to the laptop 608. The control command may be transmitted to control the third speaker 616, and the fourth speaker 618 associated with the laptop 608 to output a first audio channel signal and a second audio channel signal of the second set of audio channel signals. Based on the reception of the transmitted control command, the laptop 608 may be configured to control the third speaker 616 to output the first audio channel signal of the second set of audio channel signals. Further, the laptop 608 may control the fourth speaker 618 to output the second audio channel signal of the second set of audio channel signals. The audio signal channels when rendered via the corresponding speakers may provide an immersive surround sound experience to the user 606. Such immersive second set of audio channel signals may be experienced by the user based on the placement of the first speaker 610, and the second speaker 612 behind the user 606 and the placement of the third speaker 616, and the fourth speaker 618 in-front of the user 606. Such setup of placement of the speaker in-front and behind the user 606 may create an illusion of a depth and a space in the audio portion of the media content, thereby providing the immersive surround sound experience to the user 606.

As an example, the user 606 may be playing a game on the laptop 608. The game (or the gaming content) may include a visual content and an audible content. The visual content and the audible may be essential aspects of the game that may greatly enhance an overall experience of the user 606. The visual content of the game may include graphics, animations, an overall design of the environment and one or more characters of the game and the visual content may be rendered via the laptop 608. The audible content of the game may include sound effects, a background music, a voice acting, and a chatter between teammates or opponents of the user 606. The sound effects may make the game feel more realistic and may add to an immersion factor to the game. The background music may set a tone and a mood of the game, and the voice acting may bring the one or more characters of the game to life. In an embodiment, the headrest apparatus 602 may be configured to direct the sound effects of the audio content to at least one of the third speaker 616, and the fourth speaker 618 that may be placed in-front of the user 606 for a rendering purpose. The headrest apparatus 602 may be further configured to direct the background music, the voice acting, and the chatter between the teammates or the opponents of the user 606 to at least one of the first speaker 610, and the second speaker 612 that may be placed behind the user 606 fort the rendering purpose. In another embodiment, the headrest apparatus 602 may be configured to direct only the chatter between the teammates or the opponents of the user 606 to at least one of the first speaker 610, and the second speaker 612 placed behind the user 606 for rendering, and thereby allowing the user 606 to enjoy a full surround sound experience while playing the game and to not dilute the in-game audio (such as the sound effects, the background music, and the voice acting) with the chatter between the teammates or the opponents.

In an embodiment, if the user 606 may be in a meeting or chatting with a first user on a platform (such as a social networking platform or a gaming platform), the headrest apparatus 602 may be configured to control the microphone 614 to capture a voice signal associated with a voice of the user 606. The microphone 614 may transmit the captured voice signal to the headrest apparatus 602. The headrest apparatus 602 may be further configured to transmit the voice signal to the laptop 608 for further processing (such as transmission to a user device associated with the first user).

In another embodiment, the headrest apparatus 602 may be configured to control the microphone 614 to capture a noise signal. The captured noise signal may be associated with a noise within a pre-determined distance of the headrest apparatus 602. The headrest apparatus 602 may be further configured to suppress the noise based on execution of the set of operations as described in FIG. 4.

FIG. 7 is a diagram 700 that depicts a back view of a headrest apparatus 702 positioned with respect to a head of a seating apparatus for providing surround sound experience to the user. FIG. 7 is explained in conjunction with elements from FIG. 1, FIG. 2, FIG. 3, FIG. 4, FIG. 5, and FIG. 6. There is further shown a first audio rendering device 704, a second audio rendering device 706, a first audio capture device 708, and a second audio capture device 710.

The first audio rendering device 704 may be disposed at a first location which may be on a left hand side of headrest apparatus 702 and may be controlled to output the first audio control signal of the first set of audio channel signals. The second audio rendering device 706 may be disposed at a second location which may be on a right hand side of headrest apparatus 702 and may be controlled to output the second audio control signal of the first set of audio channel signals. Details about the audio channel signals are provided, for example, in FIG. 1, FIG. 3, and FIG. 5.

The headrest apparatus 702 may further include the first audio capture device 708 to capture a voice signal associated with a voice of a user who may be sitting on a seating apparatus associated with the headrest apparatus 702. Details about the captured voice signal are provided, for example, in FIG. 6. The headrest apparatus 702 may further include the second audio capture device 710 to capture a noise signal. The captured noise signal may be associated with a noise within a pre-determined distance of the headrest apparatus 702. Details about the noise signals are provided, for example, in FIG. 4. The headrest apparatus 702 may further include a mounting mechanism 712 with which the headrest apparatus 702 may be detachably attached to a seating apparatus as shown in FIG. 8.

It may be noted that the placement of the first audio rendering device 704 at the first location of the headrest apparatus 702, and the second audio rendering device 706 at the second location of the headrest apparatus 702 behind the user may be used for providing the immersive surround sound experience to the user using the headrest apparatus 702. Therefore, the first location and the second location may be chosen carefully to deliver the immersive surround sound experience to the user.

FIG. 8 is a diagram 800 of that depicts a headrest apparatus attached to a seating apparatus, in accordance with some embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown the diagram 800 that includes the headrest apparatus 802 that may be attached to a seating apparatus 804. The headrest apparatus 802 may be an exemplar embodiment of the headrest apparatus 702 of FIG. 7.

The seating apparatus 804 may correspond to a furniture that may be designed for a sitting purpose of a user (such as the user 606). The seating apparatus may include an armrest 806, a backrest 808, a cylinder 810, and a base 812. The armrest 806 of the seating apparatus 804 may support the arm and shoulder of the user while the user is sitting on the seating apparatus 804. The backrest 808 may provide support to the back, especially the lower lumbar region of the back of the user. The cylinder 810 may be used to adjust a height of the seating apparatus 804 and the base 812 may be used to provide stability, support and helps to distribute the weight of the user sitting on the seating apparatus 804 evenly.

In an embodiment, the headrest apparatus 802 may be attached to the seating apparatus 804 via the mounting mechanism 712 of FIG. 7. The user may be able to attach or detach the headrest apparatus 802 from the seating apparatus 804 as per their convenience using the mounting mechanism 712. Therefore, the disclosed headrest apparatus 802 may be attached to existing seating apparatus without any modification.

It may be noted that the seating apparatus 804 shown in FIG. 8 is a chair. However, the disclosure may not be limited to the chair may correspond to other seating apparatus such as a sofa, a couch, a bed, a recliner, and the like.

FIG. 9 is a flowchart that illustrates an exemplar method 900 for providing surround sound experience to user, in accordance with some embodiment of the disclosure. FIG. 9 is explained in conjunction with elements from FIG. 1, FIG. 2, FIG. 3, FIG. 4, FIG. 5, FIG. 6, FIG. 7, and FIG. 8. With reference to FIG. 9, there is shown the flowchart. The operations of the exemplar method 900 may be executed by any computing system, for example, by the headrest apparatus 102 of FIG. 1 or the processor 202 of FIG. 2. The operations of the flowchart 900 may start at 902.

At 902, the headrest apparatus 102 may receive the audio portion 502 of the media content from the electronic device 106. In at least one embodiment, the processor 202 may be configured to receive from the electronic device 106, the audio portion 502 of the media content. Details about the reception of the audio portion of the media content are provided, for example, in FIG. 1, and FIG. 3.

At 904, the plurality of audio channel signals 504 may be determined. The plurality of audio channel signals 504 may be determined from the received audio portion. The determined plurality of audio channel signals 504 may include at least a first set of audio channel signals 506 corresponding to the set of rear audio channel signals of the audio portion 502. In at least one embodiment, the processor 202 may be configured to determine the plurality of audio channel signals 504 from the received audio portion 502, wherein the determined plurality of audio channel signals 504 includes at least the first set of audio channel signals 506 corresponding to the set of rear audio channel signals of the audio portion 502. Details about the plurality of audio channel signals 504 are provided, for example, in FIG. 1, FIG. 3, and FIG. 5.

At 906, the first audio rendering device 104A may be controlled. The first audio rendering device 104A may be controlled to output the first audio channel signal 506A of the first set of audio channel signals 506. In at least one embodiment, the processor 202 may be configured to control the first audio rendering device 104A to output the first audio channel signal 506A of the first set of audio channel signals 506. Details about the controlling of the first audio rendering device 104A are provided, for example, in FIG. 1, FIG. 3, and FIG. 5.

At 908, the second audio rendering device 104B may be controlled. The second audio rendering device 104B may be controlled to output the second audio channel signal 506B of the first set of audio channel signals 506. In at least one embodiment, the processor 202 may be configured to control the second audio rendering device 104B to output the second audio channel signal 506B of the first set of audio channel signals 506. Details about the controlling of the second audio rendering device 104B are provided, for example, in FIG. 1, FIG. 3, and FIG. 5. Control may pass to end.

Various embodiments of the disclosure may provide a non-transitory computer readable medium and/or storage medium having stored thereon, instructions executable by a machine and/or a computer to operate a headrest system (e.g., the headrest apparatus 102) for providing surround sound experience to user. The instructions may cause the machine and/or computer to perform operations that include controlling one or more processors (e.g., the processor 202). The operations may include receiving an audio portion (e.g., the audio portion 502) of a media content from an electronic device (e.g., the electronic device 106). The operations may further include determining a plurality of audio channel signals (e.g., the plurality of audio channel signals 504) from the received audio portion. The determined plurality of audio channel signals may include at least a first set of audio channel signals. The operations may further include controlling a first audio rendering device (e.g., the first audio rendering device 104A) to output a first audio channel signal (e.g., the first audio channel signal 506A) of the first set of audio channel signals. The operations may further include controlling a second audio rendering device (e.g., the second audio rendering device 104B) to output a second audio channel signal (e.g., the second audio channel signal 506B) of the first set of audio channel signals.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A headrest apparatus, comprising:
a first audio rendering device embedded at a first position in the headrest apparatus;
a second audio rendering device embedded at a second position in the headrest apparatus;
a processor; and
a memory communicatively coupled to the processor, wherein the memory stores a plurality of processor-executable instructions which upon execution by the processor cause the processor to:
receive, from an electronic device, an audio portion of a media content;
determine a plurality of audio channel signals from the received audio portion, wherein the determined plurality of audio channel signals comprises at least a first set of audio channel signals corresponding to a set of rear audio channel signals of the audio portion;
control the first audio rendering device to output a first audio channel signal of the first set of audio channel signals; and
control the second audio rendering device to output a second audio channel signal of the first set of audio channel signals.

2. The headrest apparatus according to claim 1, wherein the processor is configured to transmit a control command to the electronic device, wherein the electronic device is configured to control a set of audio rendering devices associated with the electronic device, to output a second set of audio channel signals of the plurality of audio channel signals, based on the transmitted control command.

3. The headrest apparatus according to claim 2, wherein the second set of audio channel signals corresponds to a set of front audio channel signals.

4. The headrest apparatus according to claim 1, wherein the media content corresponds to one of an audio content, a video content, a gaming content, or a meeting content.

5. The headrest apparatus according to claim 1, further comprising a first audio capture device, and wherein the processor is further configured to:
control the first audio capture device to capture a voice signal associated with a voice of a user associated with the headrest apparatus; and
transmit the captured voice signal to the electronic device.

6. The headrest apparatus according to claim 1, further comprising a second audio capture device, and wherein the processor is further configured to:
control the second audio capture device to capture a noise signal, wherein the captured noise signal is associated with a noise within a pre-determined distance of the headrest apparatus;
generate an anti-noise signal based on the captured noise signal, wherein a phase of the generated anti-noise signal is opposite with respect to a phase of the captured noise signal;
combine the captured noise signal, the generated anti-noise signal, and at least one of the first audio channel signal or the second audio channel signal to create a noise-free signal; and
control at least the first audio rendering device or the second audio rendering device to output the created noise-free signal.

7. The headrest apparatus according to claim 1, further comprising a set of control interfaces, and wherein the processor is further configured to communicate with the set of control interfaces to control at least one of: a power supply to the headrest apparatus, a power supply to at least one of a first audio capture device or a second audio capture device, a network connection between the headrest apparatus and the electronic device, a playback of the first set of audio channel signals, one or more audio signal parameters associated with the first set of audio channel signals, and one or more audio rendering device parameters associated with at least one of the first audio rendering device and the second audio rendering device.

8. The headrest apparatus according to claim 7, wherein the one or more audio signal parameters comprises at least one of: a bandwidth associated with the first set of audio channel signals, a nominal level associated with the first set of audio channel signals, a bit rate associated with the first set of audio channel signals, a power level associated with the first set of audio channel signals, and a voltage level associated with the first set of audio channel signals.

9. The headrest apparatus according to claim 7, wherein the one or more audio rendering device parameters comprises at least one of: a volume associated with at least one of the first audio rendering device or the second audio rendering device, a bass associated with at least one of the first audio rendering device or the second audio rendering device, and a treble associated with at least one of the first audio rendering device or the second audio rendering device.

10. The headrest apparatus according to claim 1, wherein the headrest apparatus is detachably attached to a seating apparatus.

11. The headrest apparatus according to claim 1, wherein the determined plurality of audio channel signals further comprises a third set of audio channel signals, and wherein the third set of audio channel signals corresponds to a set of center audio channel signals.

12. A method implemented by a headrest apparatus, the method comprising:
receiving, from an electronic device, an audio portion of a media content;
determining a plurality of audio channel signals from the received audio portion, wherein the determined plurality of audio channel signals comprises at least a first set of audio channel signals corresponding to a set of rear audio channel signals of the audio portion;
controlling a first audio rendering device, embedded at a first position in the headrest apparatus, to output a first audio channel signal of the first set of audio channel signals; and
controlling a second audio rendering device, embedded at a second position in the headrest apparatus, to output a second audio channel signal of the first set of audio channel signals.

13. The method according to claim 12, further comprising transmitting a control command to the electronic device, wherein the electronic device is configured to control a set of audio rendering devices associated with the electronic device, to output a second set of audio channel signals of the plurality of audio channel signals, based on the transmitted control command.

14. The method according to claim 13, wherein the second set of audio channel signals corresponds to a set of front audio channel signals.

15. The method according to claim 12, wherein the media content corresponds to one of an audio content, a video content, a gaming content, or a meeting content.

16. The method according to claim 12, further comprising:
controlling a first audio capture device to capture a voice signal associated with a voice of a user associated with the headrest apparatus; and
transmitting the captured voice signal to the electronic device.

17. The method according to claim 12, further comprising:
controlling a second audio capture device to capture a noise signal, wherein the captured noise signal is associated with a noise within a pre-determined distance of the headrest apparatus;
generating an anti-noise signal based on the captured noise signal, wherein a phase of the generated anti-noise signal is opposite with respect to a phase of the captured noise signal;
combining the captured noise signal, the generated anti-noise signal, and at least one of the first audio channel signal or the second audio channel signal to create a noise-free signal; and
controlling at least the first audio rendering device or the second audio rendering device to output the created noise-free signal.

18. The method according to claim 12, wherein the determined plurality of audio channel signals further comprises a third set of audio channel signals, and wherein the third set of audio channel signals corresponds to a set of center audio channel signals.

19. The method according to claim 12, wherein the headrest apparatus comprises a set of control interfaces to control at least one of: a power supply to the headrest apparatus, a power supply to at least one of a first audio capture device or a second audio capture device, a network connection between the headrest apparatus and the electronic device, a playback of the first set of audio channel signals, one or more audio signal parameters associated with the first set of audio channel signals, and one or more audio rendering device parameters associated with at least one of the first audio rendering device and the second audio rendering device.

20. A non-transitory computer-readable medium having stored thereon, computer-executable instructions that when executed by a headrest apparatus, causes the headrest apparatus to execute operations, the operations comprising:
receiving, from an electronic device, an audio portion of a media content;
determining a plurality of audio channel signals from the received audio portion, wherein the determined plurality of audio channel signals comprises at least a first set of audio channel signals corresponding to a set of rear audio channel signals of the audio portion;
controlling a first audio rendering device, embedded at a first position in the headrest apparatus, to output a first audio channel signal of the first set of audio channel signals; and
controlling a second audio rendering device, embedded at a second position in the headrest apparatus, to output a second audio channel signal of the first set of audio channel signals.
